(19) United States
(12) Patent Application Publication
(10) Pub. No.: US 2005/0191000 A1
(43) Pub. Date: Sep. 1, 2005

(54) Bearing assembly with improved lubricating system

(75) Inventors: Chin-Long Ku, Tu-Cheng (TW); Chin-Wen Yeh, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-cheng City (TW)

(21) Appl. No.: 10/892,069

(22) Filed: Jul. 15, 2004

(30) Foreign Application Priority Data
Feb. 28, 2004 (CN) 200420043234.6

(51) Int. Cl. F16C 33/02

(52) U.S. Cl. 384/279

(57) ABSTRACT

A bearing assembly includes a stationary member and rotary member (2) arranged pivotable relative to the stationary member, and a lubricating oil storage (3) attached to the rotary member. The rotary member is spaced from the stationary member with a distance to define a space (5) therebetween. The lubricating oil storage is made of wicking material and received in the space in a manner that the lubricating oil storage does not contact the stationary member. During operation, the lubricating oil storage is rotated with the rotary member, and the lubricating oil of the lubricating oil storage is drawn out and sprayed onto contact areas of the rotary member and the stationary member by a centrifugal force.

### TECHNICAL FIELD

The present invention relates generally to bearing assembly, and more particularly to a lubricating system for a bearing assembly for use in a computer cooling fan.

### BACKGROUND

Conventional self-lubricating bearing assemblies use lubricating oil for lubricating and reducing the abrasion on the bearings and the rotary shafts. A typical bearing of this kind is made of porous material such as sintered metal. An amount of lubricating oil is poured into the bearing, and gradually leaves the bearing in a form of flowing lubricating oil during later operation. A part of the oil vaporizes or flows out of the bearing assembly during operation, or volatilizes even at the room temperature, so that the amount of lubricating oil is gradually reduced. Finally, the oil is exhausted. As a result, “dry friction” occurs on both contacting surfaces of the bearing and shaft. The bearing wears rapidly in this situation. As the wear becomes worse, the rotation of the shaft becomes unstable, the rotational precision decreases quickly, disgusting noise will be generated, and the lifespan of the bearing will thus be shortened.

For the foregoing reasons, there is a need for a bearing assembly having a lubricating system which can prevent the loss of the lubricating oil, reduce the abrasion of the bearing, and thus extend the lifespan of the bearing.

### SUMMARY OF THE INVENTION

The present invention is directed to a bearing assembly having a lubricating system capable of effectively reducing the loss of the lubricating oil for the bearing system.

A bearing assembly having features of the present invention comprises a stationary member and rotary member installed and adapted to be relatively rotatable, and a lubricating oil storage attached to the rotary member. The rotary member is spaced from the stationary member with a distance to define a hollow-columned space therebetween. The lubricating oil storage is made of wicking material and received in the space in a manner that the lubricating oil storage does not contact the stationary member. During operation, the lubricating oil storage is rotated with the rotary member, and the lubricating oil of the lubricating oil storage is drawn out and sprayed onto contact areas of the rotary member and the stationary member by a centrifugal force.

Other objects, advantages and novel features of the present invention will be drawn from the following detailed description of the preferred embodiments of the present invention with attached drawings, in which:

### BRIEF DESCRIPTION OF THE DRAWINGS

FIG. 1 is a cross sectional view of a preferred embodiment of a bearing assembly embodying features of the present invention;

FIG. 2 is a top view of the shaft and the lubricating oil storage of the bearing assembly of FIG. 1;

FIG. 3 is a top view of an alternative embodiment of the shaft and the lubricating oil storage of FIG. 2;

FIG. 4 is a plan view of an alternative embodiment of the shaft of the bearing assembly of FIG. 1;

FIG. 5 is an elevational view of an alternative embodiment of the shaft of the bearing assembly of FIG. 1; and

FIGS. 6 and 7 are cross sectional view of an alternative embodiment of a bearing assembly embodying features of the present invention.

### DESCRIPTION OF PREFERRED EMBODIMENTS

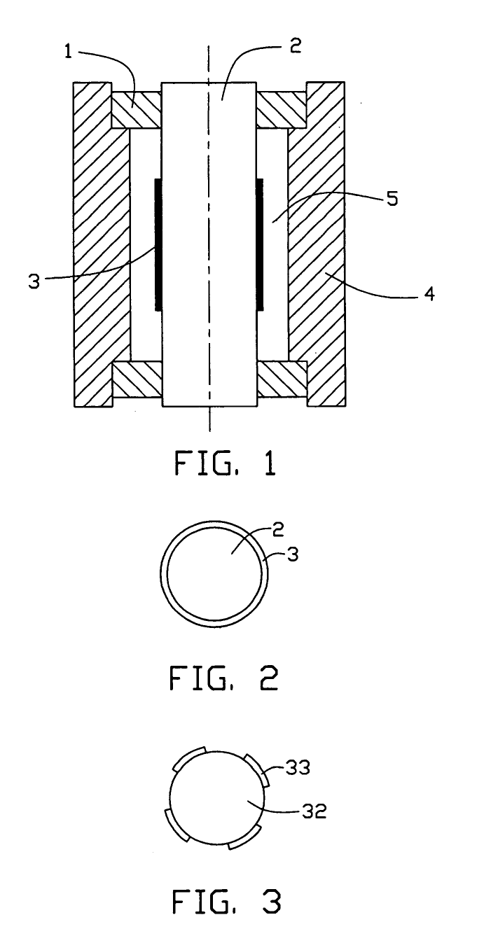

Referring to FIG. 1, a bearing assembly according to a preferred embodiment comprises a tube 4, two radial bearings 1 fixed in the tube 4 at two opposite ends thereof, a shaft 2 received in the tube 4 with portions supported by the radial bearings 1, and a lubricating oil storage 3 attached around the shaft 2.

The shaft 2 extends through the two bearings 1. One end of the shaft 2 is used for carrying an object for rotation, such as a fan blade set. The shaft 2 has a porous body into which an amount of lubricating oil is poured therein before use. Each bearing 1 has an inner periphery bearing against the outer surface of the shaft 2. An inner wall of the tube 4 located between the radial bearings 1 is spaced a distance from the outer surface of the shaft 2. A hollow-columned space 5 is therefore formed between the shaft 2, the bearings 1 and the tube 4.

Referring also to FIG. 2, the lubricating oil storage 3 has a hollow cylindrical structure, and is made of wicking material. Preferably, the lubricating oil storage 3 is made of flexible wicking material, so that it can be maintained on the shaft 2 by its own resilient force. The lubricating oil storage 3 is used to suck the oil out from the shaft 2 and reserve the lubricating oil therein. The thickness of the lubricating oil storage 3 is less than the broadness of the space 5 between the shaft 2 and the tube 4, so that the lubricating oil storage 3 does not contact the tube 4 when rotating with the shaft 2. Therefore, the lubricating oil storage 3 will not be worn out during rotation of the shaft 2.

In operation, the shaft 2 is pivoted in the tube 4 with friction existed between the outer surface of the shaft 2 and the inner periphery of the bearing 1. The lubricating oil storage 3 is driven to rotate with the rotary shaft 2. As a subject to a centrifugal force, the lubricating oil in the lubricating oil storage 3 is drawn out and sprayed onto the bearing 1 for lubricating the outer surface of the shaft 2 and the inner periphery of the bearing 1 where friction exists.

When the shaft 2 ceases pivoting, the outer-flowing lubricating oil is wicked through the shaft 2 back into the lubricating oil storage 3, and is reserved therein for reducing volatilization of the lubricating oil. The loss of the lubricating oil is thus effectively reduced.

Referring to FIG. 3, a lubricating oil storage 33 according to an alternative embodiment is illustrated. The lubricating oil storage 33 comprises a plurality of spaced lubricating films attached around the shaft 32 by adhering. Similar to the lubricating oil storage 3 mentioned above, the lubricating oil storage 33 is made of wicking material for reserving lubricating oil therein.

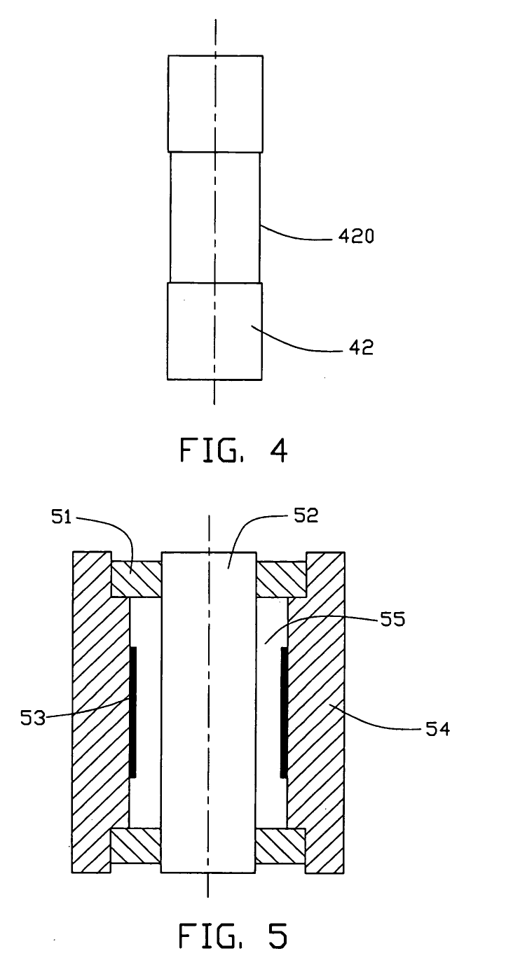

FIG. 4 shows a shaft 42 according to an alternative embodiment. An annular groove 420 is formed at a middle periphery portion of the shaft 42. The groove 420 receives the whole or at least part of the lubricating oil storage 3 or 33 therein for retaining the lubricating oil storage 3 or 33 in place.

In the bearing assembly of the foregoing embodiments, the shaft 2 or 32 is a rotary member, and a combination of the bearings 2 and the tube 4 is a stationary member. The lubricating oil storage 3 or 33 is attached to the rotary member to rotate therewith. Understandably, in another alternative bearing assembly, bearings can be rotary members, and the shaft can be the stationary member.

Referring to FIG. 5, a bearing assembly with a stationary shaft is illustrated. A combination of two bearings 51 and a tube 54 is a rotary member, and a shaft received in the tube 54 is a stationary member. A space 55 is formed between the rotary member and the stationary member. Lubricating oil storage 53 is attached to the inner wall of the tube 54 of the rotary member. During rotation of the rotary member, the lubricating oil storage 53 does not contact the stationary member, namely the shaft 52. The inner wall of the tube 54 comprises porous structures containing lubricating oil therein. The lubricating oil storage 53 is made of wicking material, and works in substantially the same way with the foregoing embodiments.

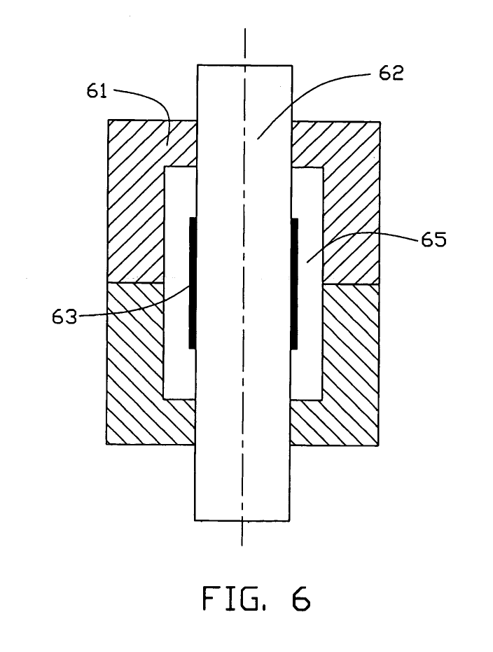

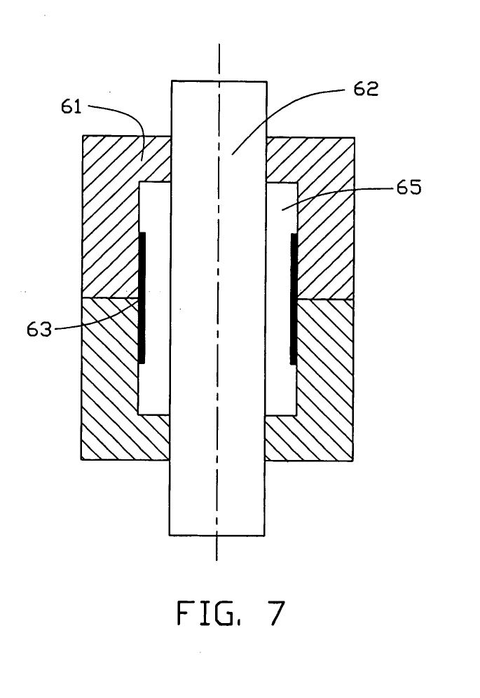

Referring to FIGS. 6 and 7, a bearing assembly according to another alternative embodiment is illustrated. A combination bearing 61 comprises upper and lower parts each having a bearing portion. A shaft 62 is received in the bearing 61 with portions supported by the bearing portions of the bearing 61. A cavity 65 is defined in an inner bore of the combination bearing 61. Lubricating oil storage 63 is installed within the cavity 65 for lubricating the bearing 61. When the shaft 62 is a rotary member, the lubricating oil storage 63 is attached to the shaft 62. When the bearing 61 is a rotary member, the lubricating oil storage 63 is attached to the inner wall of the bearing 61.

It is understood that the invention may be embodied in other forms without departing from the spirit thereof. The above-described examples and embodiments are to be considered in all respects as illustrative and not restrictive, and the invention is not to be limited to the details given above.

1. A bearing assembly comprising:
a stationary member;
a rotary member having porous structures containing lubricating oil therein and being capable of rotating relative to the stationary member, the rotary member radially spaced from the stationary member with a distance to define a space therebetween; and
a lubricating oil storage made of wicking material capable of wicking the lubricating oil out from the rotary member and reserving the lubricating oil therein, the lubricating oil storage received in said space in a manner that the lubricating oil storage does not contact the stationary member, the lubricating oil storage being drivable to rotate with the rotary member to cause the lubricating oil to be drawn out and sprayed onto contact areas between the rotary member and the stationary member by a centrifugal force.

2. The bearing assembly as described in claim 1, wherein the rotary member comprises a shaft, and the lubricating oil storage is attached around the shaft.

3. The bearing assembly as described in claim 2, wherein the shaft defines an annular groove at an outer periphery thereof receiving the lubricating oil storage therein.

4. The bearing assembly as described in claim 1, wherein the rotary member comprises a tube and a pair radial bearings fixed in the tube at opposite ends of the tube, and the lubricating oil storage is attached to an inner wall of the tube.

5. The bearing assembly as described in claim 1, wherein the rotary member comprises a bearing having an inner bore, and the bearing defines a cavity at the inner bore receiving the lubricating oil storage therein.

6. The bearing assembly as described in claim 1, wherein the lubricating oil storage has a cylindrical shape.

7. The bearing assembly as described in claim 6, wherein the lubricating oil storage is flexible, and is attached to the rotary member by its own resilient force.

8. The bearing assembly as described in claim 1, wherein the lubricating oil storage comprises a plurality of lubricating films adhered to the rotary member.

9. A bearing assembly comprising:
a stationary member;
a rotary member rotatably connected to the stationary member with a space formed between the stationary member and the rotary member; and
a lubricating oil storage received in the space and capable of rotating with the rotary member to draw lubricating oil stored in the oil storage out to spray to contact areas between the stationary member and the rotary member, the lubricating oil storage capable of sucking lubricating oil spread on said contact areas and reserving the lubricating oil therein when the rotary member stop rotating.

10. The bearing assembly as described in claim 9, wherein the lubricating oil storage is made of wicking material.

11. The bearing assembly as described in claim 10, wherein the lubricating oil storage is made of resilient wicking material.

12. The bearing assembly as described in claim 1, wherein the lubricating oil storage is mounted on the rotary member and spaced from the rotary member with a distance.
